(19) United States
(12) Patent Application Publication
(10) Pub. No.: US 2011/0299858 A1
(43) Pub. Date: Dec. 8, 2011

(54) HOST DEVICE WITH MULTIPURPOSE OPTICS DRIVE CAPABILITIES

(75) Inventors: Marco Mazzini, Sesto San Giovanni (IT); Cristiana Muzio, Ivrea (IT); Eliana Vercelli, Milano (IT)

(73) Assignee: CISCO TECHNOLOGY, INC., San Jose, CA (US)

(21) Appl. No.: 12/796,036

(22) Filed: Jun. 8, 2010

(51) Int. Cl. H04B 10/12; H04B 10/04

(52) U.S. Cl. 398/183; 398/200

(57) ABSTRACT

A host device is provided that can leverage multiple optical modulation scheme capabilities of the optical module. The host device comprises an electrical modulator unit configured to generate electrical transmit signals comprising modulated data in a modulation format, and a connector configured to connect to the optical module that transmits optical signals to an optical fiber. The host device comprises a controller that is configured to select one of a plurality of optical modulation schemes for an optical reach, and to generate a control signal for supply to the optical module via the connector. The control signal is configured to cause the optical module to generate optical signals from the electrical transmit signals according to the selected optical modulation scheme.

### TECHNICAL FIELD

The present disclosure relates to networks, and more particularly to configuring a host device with the capabilities to drive an optics module with different modulation schemes.

### BACKGROUND

Different optical reaches for fiber optic communication systems are available depending on the types of applications and platforms. For example, optics for Data Center/Internet backbone at 10 Gigabit Ethernet (GE) is regulated by IEEE 802.3 standard. On the other hand, optical transport is done using wavelength division multiplexed (WDM) interfaces to support the continuous bandwidth increase. 10G bit/s client interfaces are already moving to 40 Gb/s, and the IEEE task force is working to release the 40/100GE standard IEEE 802.3ba.

In particular for 100 GBase interface, the IEEE 802.3ba standard allows two different implementations for 10 and 40 km, both based on cooled CWDM lasers in the 1300 nm window. 100 GBASE-LR4 (Long Reach) and 100 GBASE-ER4 (Extended Reach) consist of the same set of 4 wavelengths, but to reduce costs the transmit and receive characteristics for 100 GBASE-LR4 are more relaxed than ER4 since the target distance for LR4 is shorter.

The industry is now concentrating on moving the electrical signal processing/conditioning for transmit and receive signals to the host card where most of the electrical signal processing is performed. There are opportunities to leverage the host capabilities to accommodate different types of optical modulation schemes performed in the optical module to which the host device connects.

### BRIEF DESCRIPTION OF THE DRAWINGS

FIG. 1 is an example of a block diagram of a host device configured to generate controls for an optical module according to a selected modulation scheme.

FIG. 2 is an example of a block diagram of a host device and an optical module according to a first configuration for controlling the optical module.

FIG. 3 is an example of plots of bias values to be used by the optical module for different modulation schemes.

FIG. 4 is an example of a block diagram of a host device and an optical modulate according to a second configuration for controlling the optical module.

FIG. 5 is an example of a flow chart depicting operations of the host device and optical module according to the first configuration shown in FIG. 2.

FIG. 6 is an example of a flow chart depicting operations of the host device and optical module according to the first configuration shown in FIG. 4.

FIG. 7 is an example of a block diagram of a host device and optical module according to a third configuration.

FIGS. 8 and 9 are tables illustrating examples of transmit and receive optical parameters for an optical module that is capable of supporting a plurality of modulation schemes.

### DESCRIPTION OF EXAMPLE EMBODIMENTS

Overview

A host device is provided that can leverage multiple optical modulation scheme capabilities of the optical module. The host device comprises an electrical modulator unit configured to generate electrical transmit signals comprising modulated data in a modulation format, and a connector configured to connect to the optical module that transmits optical signals to an optical fiber. The host device comprises a controller that is configured to select one of a plurality of optical modulation schemes for an optical reach, and to generate a control signal for supply to the optical module via the connector. The control signal is configured to cause the optical module to generate optical signals from the electrical transmit signals according to the selected optical modulation scheme.

### Example Embodiments

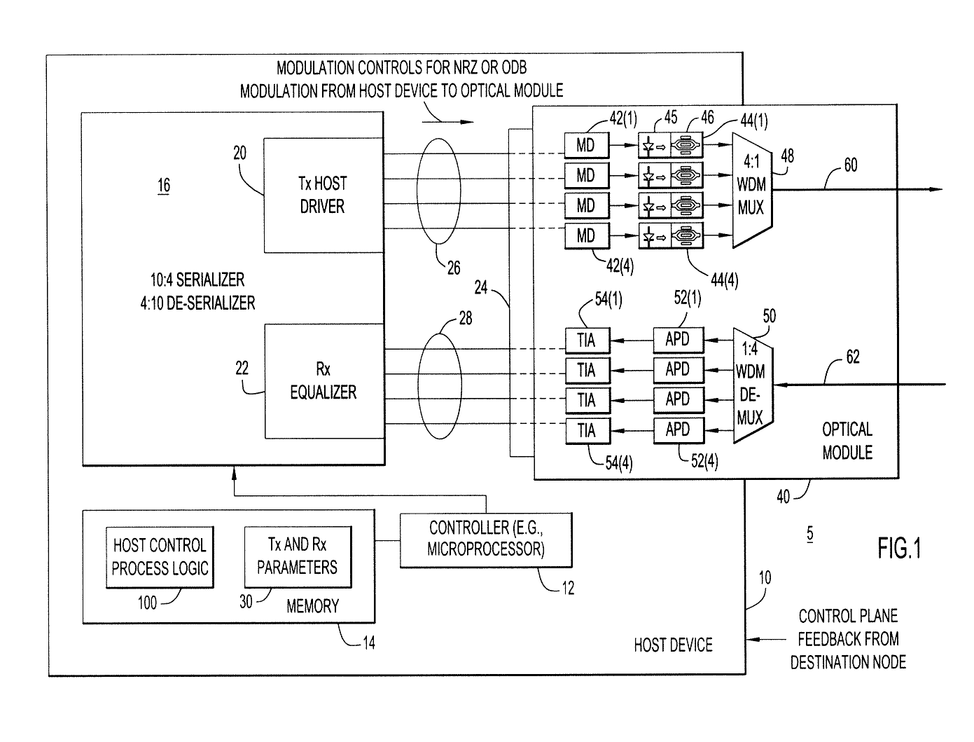

Reference is first made to FIG. 1. FIG. 1 shows an optical system or combination 5 comprising a host device 10 in which can be plugged an optical module 40. The host device 10 performs the electrical signal processing of electrical transmit signals to be supplied to the optical module 40 that converts the electrical transmit signals to optical signals for transmission over a fiber 60 to a destination node. Similarly, the host device performs the electrical signal processing of electrical receive signals obtained from the conversion of received optical signals on a fiber 62 from a source node.

The host device 10 comprises a controller 12 (e.g., a microprocessor or other data processing component), memory 14, a serializer/de-serializer unit 16 comprising a transmit (Tx) host driver block 20 and a receive (Rx) equalizer block 22 and a high speed connector 24. There are 4 signal lanes at 25 Gbs shown at 26 that carry electrical transmit signals from the Tx host driver block 20 to the optical module 40 via the connector 24 and signal lanes 28 that carry electrical receive signals from the optical module 40 to the Rx equalizer block 22. The Tx host driver block 20 supplies electrical transmit signals that comprise modulated data according to one of a plurality of modulation formats to the optical module 40. For example, the Tx host driver block 20 is configured to generate electrical transmit signals according to a non-return to zero (NRZ) modulation format and according to a duo binary (DB) modulation format.

The controller 12 serves as the intelligent control unit for the host device 10 and controls functions of the components of the host device 10 as well as supplies control signals to the optical module 40 as described further hereinafter. The memory 14 stores a variety of data and in particular stores data for Tx and Rx parameters 30 to be used by the host device depending on the type of modulation scheme to be employed. The controller 12 supplies control signals to the serializer/de-serializer 16 and to the optical module 40 as described further herein. In particular, the Tx host driver block 20, in response to a control from the controller 12, supplies a control signal, via the connector 24, to the optical module 40 to drive the optical module over different optical modulation schemes according to the desired optical reach. In this way, the requirements for the 100 GBASE LR4 and 100 GBASE ER4 reaches can be accommodated with the same optical module and host device, but a change in modulation format is made under control of the host device. For example, the 10 km (LR4) leverages the NRZ modulation format whereas the 40 km reach uses the DB format. The host device 10 makes high-speed electrical connectors for both reaches accessible and selectable in the same device. The host device 10 changes the maximum reach by changing the modulation format of the electrical transmit signals supplied to the optical module 40 and by controlling the optical module according to the selected optical modulation scheme.

For example, a first modulation format for the modulated data of the electrical transmit signals is used for a first optical modulation scheme, a second modulation format for the modulated data of the electrical transmit signals is used for a second optical modulation scheme. As described herein, the host device 10 may be capable of generating the electrical transmit signals in any of multiple modulation formats or may the host device 10 be capable of generating the electrical transmit signal in only one (a first) modulation format, but the optical module has an electrical modulator unit that is capable of generating electrical transmit signals from the first modulation format to electrical transmit signals in another modulation format.

The optical module 40 comprises a transmit path and a receive path. In the transmit path, there is a block of modulator drivers (MDs) 42(1)-42(4) and a block of optical modulator units 44(1)-44(4) each of which comprises, in one example, a cooled distributed feedback (DFB) laser 45 paired with a Mach-Zehender (MZ) optical modulator 46. As described hereinafter, each MD 42(1)-42(4) is accessible by the host device 10 to set different bias voltage levels, signal driver amplitudes and emphasis conditioning. Using emerging semiconductor fabrication techniques, the laser 45 and the MZ optical modulator 46 can be integrated on the same wafer in a phototonic integrated circuit (PIC). There is a 4:1 WDM multiplexer (MUX) 48 in the transmit path that multiplexes the optical signals output by the MZ optical modulators 44(1)-44(4) for supply transmission in an optical fiber 60.

In the receive path, the optical module 40 comprises a 1:4 WDM de-MUX 50 that receives as input a received optical signal and demultiplexes it into four constituent signals that are supplied as input to a corresponding one of avalanche photodiode (APD) receiver units 52(1)-52(4) that convert the individual constituent signals to electrical receive signals. The outputs of the APDs 52(1)-52(4) are supplied to corresponding ones of transimpedance amplifiers (TIAs) 54(1)-54(4) that amplify the electrical receive signals for supply to the Rx equalizer 22 in the host device 10. Thus, on the optical module receiver side, both modulation formats use a linear TIA.

On the host device receiver in the Rx equalizer 22, an adjustable decision threshold and an electronic dispersion compensator (EDC) is provided. When NRZ modulation is selected, host receiver decision threshold is adjusted to the average value. When DB is selected, host receiver decision threshold is adjusted to an optimum value.

In order to avoid the need for a semiconductor optical amplifier (SOA) in the receive path to overcome the 40 km fiber insertion loss around 1300 nm, the four wavelengths may be chosen in the so-called third window region. This implies that degradation is expected because of chromatic dispersion, but the optical duo-binary modulation will compensate for this degradation.

The controller 12 may be a programmable processor or a fixed-logic processor. In the case of a programmable processor, the memory 14 is any type of tangible processor readable memory (e.g., random access, read-only, etc.) that is encoded with or stores instructions. For example, the controller 12 is a microprocessor or microcontroller. The memory 14 stores or is encoded with instructions for host control process logic 100. Alternatively, the controller 12 may a fixed-logic processing device, such as an application specific integrated circuit or digital signal processor, that is configured with firmware comprised of instructions that cause the controller 12 to perform the functions described herein. Thus, the process logic 100 may take any of a variety of forms, so as to be encoded in one or more tangible media for execution, such as with fixed logic or programmable logic (e.g., software/computer instructions executed by a processor) and the controller 12 may be a programmable processor, programmable digital logic (e.g., field programmable gate array) or an application specific integrated circuit (ASIC) that comprises fixed digital logic, or a combination thereof. In general, the process logic 100 may be embodied in a processor readable medium that is encoded with instructions for execution by a processor (e.g., controller 12) that, when executed by the processor, are operable to cause the processor to perform the functions described herein in connection with process logic 100.

The controller 12 is configured to select one of a plurality of modulation schemes for use according to a desired optical reach, and to generate a control signal for supply to the optical module (through the Tx host driver 20, for example) that is configured to cause the optical module 40 to generate optical signals from electrical transmit signals (output by the Tx host driver 20) according to the selected modulation scheme. The controller 12 may also change the modulation scheme used by the optical module 40 from time to time.

The change in modulation can be static or dynamic. A static implementation may be preferred for an application when the reach is longer than a predetermined length, e.g., 10 km. A dynamic implementation is useful when the host device receives feedback from a destination node as to errors occurring on a particular port and automatically switches from one optical modulation scheme to another, e.g., from NRZ to ODB. This is depicted in FIG. 1 by the feedback on the control plane to the host device 10 from a destination node. The feedback is a signal that indicates or represents received performance at the destination node and the controller may be configured to automatically switch from one optical modulation scheme to another optical modulation scheme based on the feedback signal.

Described herein are two configurations for allowing a host device to drive components in the optical module 40, depending on how much signal processing capability is provided in the host device 10. In either configuration, the optical module comprises an optical modulator unit (for each signal lane) that is configured to output optical signals according to any one of a plurality of optical modulation schemes. The optical modulator unit is responsive to the control signal that contains a bias for the optical modulator unit according to the selected modulation scheme.

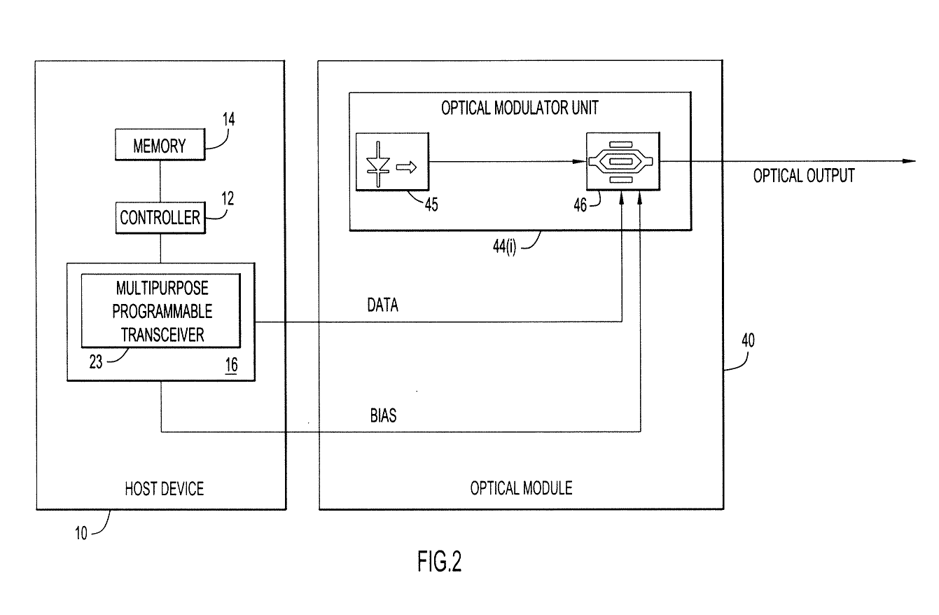

Reference is now made to FIG. 2 for a description of a first configuration for a host device 10 to drive components in the optical module 40. In this configuration, the host device 10 comprises a multipurpose programmable transceiver unit 23 that resides in, for example, the serializer/de-serializer unit 16 (see FIG. 1) of the host device 10. For simplicity, FIG. 2 illustrates the transmit path for a single electrical transmit signal (a single lane) that is supplied to an optical modulator unit identified generically at reference number 44(i) and which comprises a DFB laser 45 and a MZ optical modulator 46.

In the transmit path, the multipurpose programmable transceiver unit 23 serves as a programmable electrical modulator unit that outputs electrical transmit signals in any of multiple modulation formats, e.g., NRZ or DB modulation formats. An example of such a device that is currently available is the Broadcom 8154 ASIC (for 10 G). The multipurpose programmable transceiver unit 23 employs pre-emphasis on the transmitter side and adaptable decision threshold adjustment, receive equalization for inter-symbol interference (ISI) and electronic dispersion compensation on the receiver side. Under control of the controller 12, the multipurpose programmable transceiver unit 23 sends via the connector 24 to the optical module 40 the electrical transmit signal (shown as “Data” in FIG. 2) and bias signals (“Bias” in FIG. 2) directly to the optical modulator unit 44(i) so that the optical modulator unit 44(i) outputs a modulated optical signal in any of a plurality of optical modulation formats, e.g., NRZ or optical DB (ODB).

Thus, the host device 10 in the configuration of FIG. 2 generates electrical transmit signals comprising modulated data according to a particular one of a plurality of modulation formats based on the selected modulation scheme. In addition, the controller 12 generates a control signal that is configured to bias and drive an optical MZ modulator in the optical module to generate optical signals from the electrical transmit signals according to the selected modulation scheme.

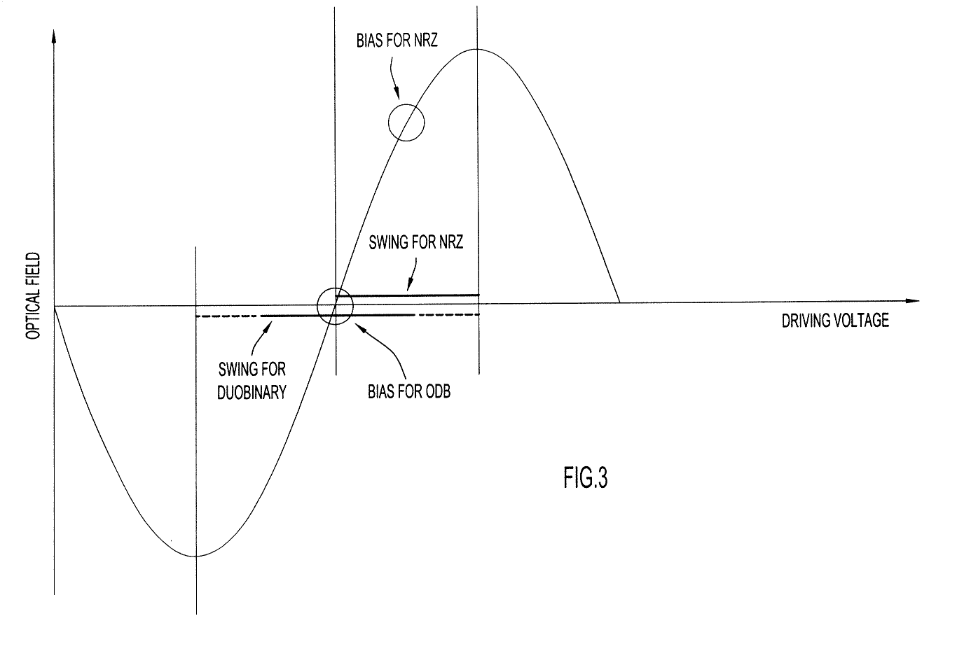

FIG. 3 illustrates plots of the bias signals and their swing ranges used for the NRZ modulation format and for the ODB modulation format. In the configuration shown in FIG. 2, the host device 10 does all the proper coding in order to have the correct modulation format and all of this is completely transparent to the optics module.

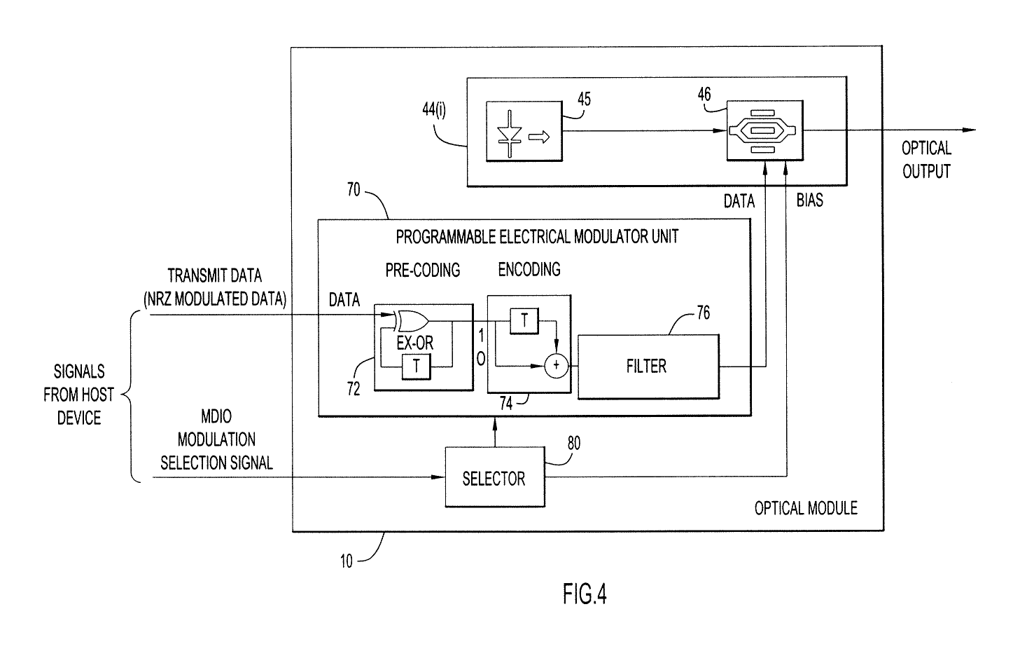

Reference is now made to FIG. 4 for a description of a configuration in which the host device 10 has the capability of generating only one type of (a first) modulation format, e.g., standard NRZ data at 25 G. In this case, the optical module 40 has a programmable electrical modulator unit 70 and a selector unit 80. The programmable modulator unit 70 is configured to receive as input modulated data according to one modulation type, e.g., NRZ modulated data, and to either pass the NRZ modulated data unprocessed to the optical modulator unit 44(i) or to process the NRZ modulated data and convert it to DB modulated data for supply to the optical modulator unit 44(i). The programmable modulator unit 70 can be directly integrated in the optical module 40 in a PIC technology. In this way, the power consumption to be added to the optic module budget will be very limited.

The electrical programmable modulator unit 70 has a pre-coding component 72, an encoding component 74 and a filter 76. The electrical programmable modulator unit 70 can operate in a by pass mode in which the pre-coding component 72, the encoding component 74 and filter 76 are bypassed. This is desirable when the NRZ modulated data from the host device is to be applied to the optical modulator unit 44(i) for NRZ optical modulation for a first reach, e.g., 10 km. On the other hand, the electrical programmable modulator unit 70 can operate in a full process mode in which the pre-coding component 72, the encoding component 74 and filter 76 are not bypassed such that the electrical programmable modulator unit 70 converts the NRZ modulated data to DB modulated data that is passed to the optical modulator unit 44(i).

The host device 10 outputs to the optical module 40 the electrical data (NRZ modulated data) and the management data input/output (MDIO) modulation selection signal. The MDIO modulation selection signal is a control flag signal that is received by the selector 80 and which in turn sets the correct configuration of the electrical programmable modulator unit 70 (bypass mode or full process mode) and sets the bias for the MZ optical modulator 46 in order to produce the optical output with the desired optical modulation.

When the host device selects a shorter reach, e.g., 10 km and consequently the NRZ modulation format, the MDIO modulation selection signal is in a first state that commands the selector 80 to control the programmable modulator unit 70 to pass the NRZ modulated data unprocessed. When the host device 10 selects a longer reach, e.g., 40 km and consequently the DB modulation format, the MDIO modulation selection signal is in a second state that commands the selector 80 to configure the electrical programmable modulator unit 70 to process the NRZ modulated data (activate the pre-coding component 72, the encoding component 74 and the filter 76) to convert the NRZ modulated data of the electrical transmit signals supplied by the host device to DB modulated data. Moreover, the correct bias will be sent to the MZ optical modulator 46 in each of the two states. When the MDIO selection signal is in the first state, the bias and drive voltage supplied by the optical module 40 to the optical modulator unit 44(i) is suitable for NRZ optical modulation and when the MDIO selection signal is in the second state, the bias and drive voltage supplied by the optical module 40 to the optical modulator 44(i) is suitable for ODB optical modulation.

The modulation can be static or dynamic. A static implementation may be preferred for an application when the reach is longer than a predetermined length, e.g., 10 km. A dynamic implementation is useful, as described above, where the host device receives feedback from a destination node as to errors occurring on a particular port and automatically switches from one modulation scheme to another, e.g., from NRZ to ODB. The dynamic modulation switching capability is beneficial to compensate for dynamic event such as optical lifetime, polarization mode dispersion (PMD), time-variant or temperature effects which can impact fiber loss such as Polarization Dependent Loss (PDL), chromatic dispersion (CD) due to laser wavelength drift, etc.

On the receive side, for the 40 km (ODB) case the host device 10 may turn on full EDC and the Rx threshold is set to an optimum value. The EDC technique may use a maximum likelihood sequence estimation (MLSE) algorithm to compensate for chromatic dispersion distortion in a DB modulated signal. Consequently, an 800 ps/nm requirement is met with good and improved margin.

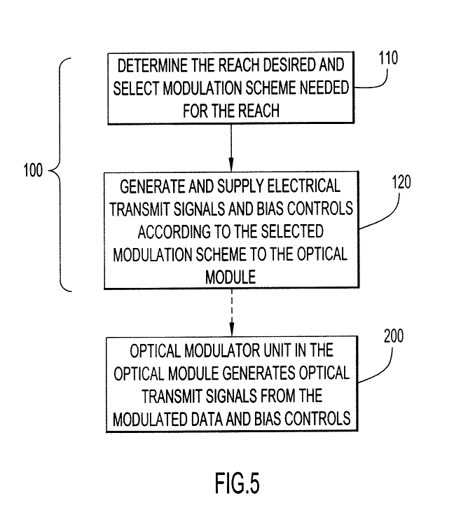

Turning now to FIG. 5, the control process logic 100 in the host device 10 is now described with respect to the configuration shown in FIG. 2. In this configuration, the host device can supply electrical transmit signals in accordance with any of a plurality of modulation formats, and also supplies the appropriate bias controls to the optical modulator unit in the optical module 40. At 110, the host device determines the optical reach desired for a link and selects the modulation scheme needed for the reach. For example, for optical reaches of a first range (a shorter reach), the host device 10 selects a first optical modulation scheme, e.g., NRZ, and for optical reaches of a second (longer range), the host device 10 selects another optical modulation scheme, e.g., ODB. At 120, the host device generates the electrical transmit signals according to the selected modulated scheme (comprising modulated data in a first modulation format, NRZ, or comprising modulated data in a second modulation format, DB) and the bias controls for the selected modulation format and supplies them to the optical module. Operations 110 and 120 are performed in the host device 10.

At 200, using the electrical transmit signals of the selected modulation format and bias controls from the host device 10, the optical modulator unit in the optical module generates optical transmit signals for transmission over an optical fiber to a destination node.

Said another way, in the configuration depicted in FIG. 2 and by the flowchart of FIG. 5, the controller 12 of the host device 10 is configured to generate a control signal comprising a bias control according to the selected modulation scheme for supply to the optical module 40 and for use by the optical modulator unit 44(i) in the optical module 40 to configure the optical modulator unit 44(i) to convert the electrical transmit signals to modulated optical signals for transmission, and without further processing of the electrical transmit signals in the electrical domain. The electrical modulator unit on the host 10 in the configuration of FIG. 2 can generate electrical transmit signals comprising modulated data according to any one of a plurality of modulation formats and is responsive to the controller 12 to generate the electrical transmit signals in a particular modulation format according to the selected modulation scheme.

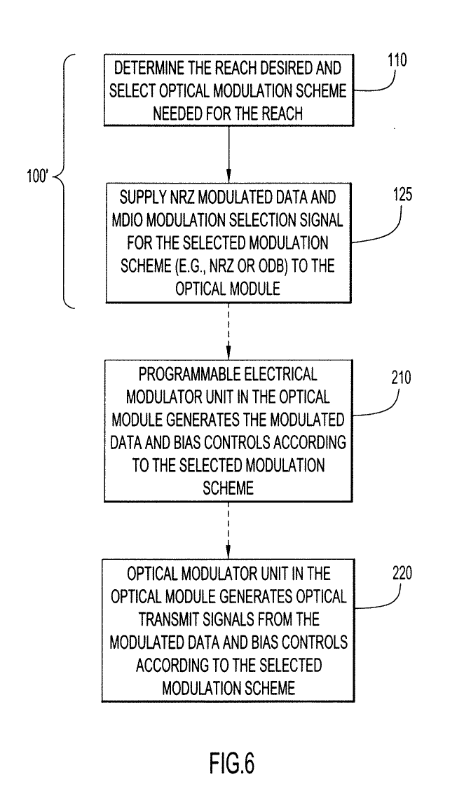

Turning now to FIG. 6, control process logic 100′ of the host device is described for the configuration shown in FIG. 4. Operation 110 is similar to that described above in connection with FIG. 5. At 125, the host device supplies modulated data according to a format, e.g., NRZ modulated data and a MDIO modulation selection signal for the selected modulation format (NRZ or ODB) to the optical module. In this case, regardless of the optical modulation scheme to be employed by the optical module, the host device supplies electrical transmit signals of the same modulation format, e.g., NRZ.

The optical module receives the supplied electrical transmit signals (NRZ modulated data) and the MDIO modulation selection signal. At 210, the programmable electrical modulator unit 70 in the optical module 40 outputs the modulated data to the optical modulator unit 44(i) either without any further processing if NRZ optical modulation is selected by the MDIO modulation selection signal or after converting the NRZ modulated data to DB modulated data if ODB optical modulation is selected by the MDIO modulation selection signal. In addition, the selector 80 of the optical module 40 supplies the necessary bias controls to the optical modulator unit 44(i) depending on the modulation scheme selected by the MDIO modulation selection signal. At 220, the optical modulator unit 44(i) in the optical module generates optical transmit signals from the modulated data and bias controls for transmission on an optical fiber to a destination node. Operation 220 is similar to operation 200 in FIG. 5.

Thus, in the configuration of FIG. 4 and as depicted by the flowchart of FIG. 6, the controller 12 in the host device is configured to generate the control signal comprising a modulation selection signal that is configured to control the programmable electrical modulator unit 70 in the optical module 40 to either further process the electrical transmit signals for supply to an optical modulator unit 44(i) in the optical module 10 or to pass the electrical transmit signals without further processing to the optical modulator 44(i) unit in the optical module. Moreover, the controller 12 is configured to generate the modulation selection signal that causes the optical module 10 to generate a bias control for the optical modulator unit 44(i) for use in converting the electrical transmit signals to optical signals according to the selected modulation scheme.

Said yet another way, the optical module 10 comprises a programmable electrical modulator unit 70 and an optical modulator unit 44(i) that is configured to output optical signals according to any one of the plurality of modulation schemes. The programmable electrical modulator unit 70 s responsive to the control signal (from the host device 10) to either convert the electrical transmit signals from a first modulation format to a second modulation format for supply to the optical modulator unit 44(i) or to bypass the electrical transmit signals in the first modulation format to the optical modulator unit 44(i), wherein the optical modulator unit 44(i) is responsive to a bias control supplied by the optical module to drive the optical modulator unit to optically modulate the electrical transmit signals according to the selected modulation scheme.

In the configurations described herein, the optical components in the optical module 40 are the same but the host device 10 configures those optical components to work differently.

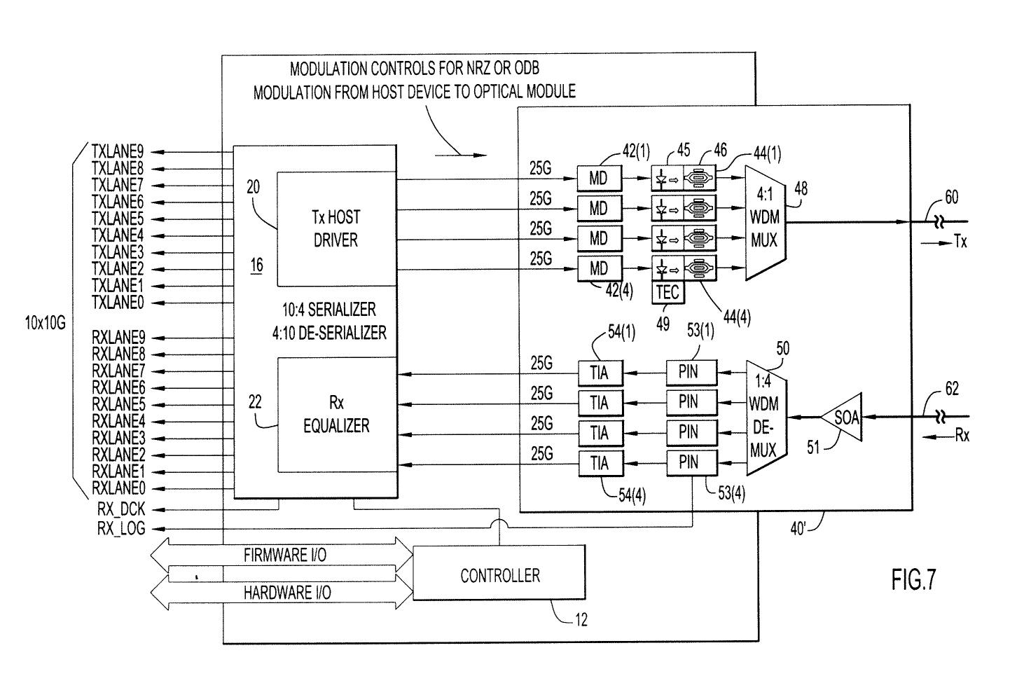

FIG. 7 illustrates a configuration for an optical module 40′ that is a multipurpose optical module which leverages four thermally-stabilized wavelengths (e.g., from 1529.5 to 1545 nm). In this example configuration, a 60 km or even 80 km optical link can be supported. The optical module 40′ connects according to the C-Form-Factor Pluggable (CFP) standard. The serializer/de-serializer 16 is connected, without a connector, to the optical transmit and receive paths. The optical module 40′ is very similar to optical module 40, with 4 MZ optical modulators 46 but the 4 DFB lasers 45 are in this case cooled through a thermal electric cooler (TEC) 49. In the receive path, there is an SOA 51 and a bank of PIN diode receivers 53(1)-53(4). To avoid the use of an internal SOA, an APD-based receive structure can be used such as that shown in FIG. 1.

The optical wavelength-to-lane assignments are, for example, as indicated in Table 1 below.

TABLE 1
Example Wavelength Lane Assignments
for Configuration of FIG. 7

| Lane | Center Wavelength | Wavelength Range |
|---|---|---|
| L0 | 1529.5 nm | 1529.5 to 1531.5 nm |
| L1 | 1535.0 nm | 1534.0 to 1536.0 nm |
| L2 | 1539.5 nm | 1538.5 to 1540.5 nm |
| L3 | 1544.0 nm | 1543.0 to 1545.0 nm |

Considering that less impairments are needed to be compensated if the optical module is in CFP format (because no electrical connector is present between the TIAs and serializer/de-serializer 16), reaches of distances longer than 40 km can be achieved, particularly when a full-25 GHz EDC (like an MLSE) is used in the receive path. Since the four lanes are chosen in an EDFA amplification window, the use of dispersion compensating units (DCUs) can further extend the link distance.

While the examples described herein are directed to parallel interfaces, it should be understood that these techniques are just as applicable to 10 G and 40 G serial interfaces.

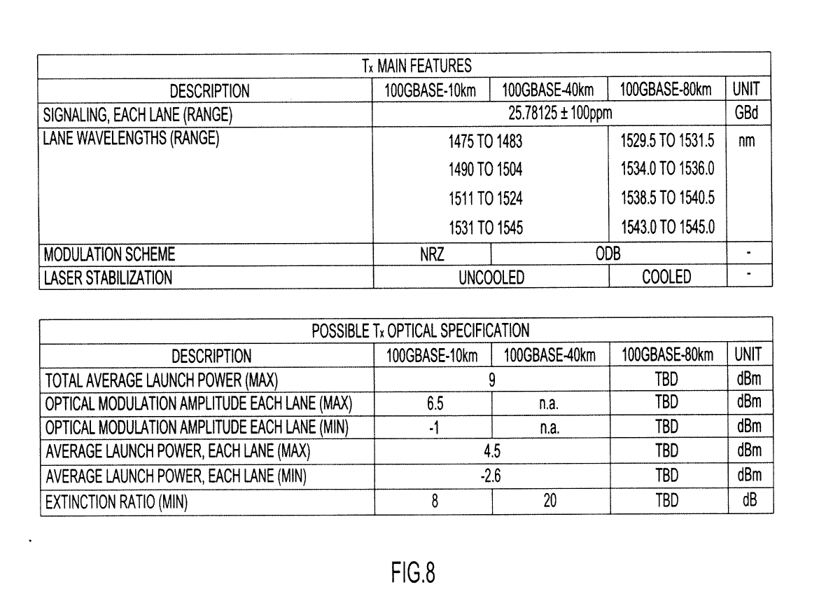

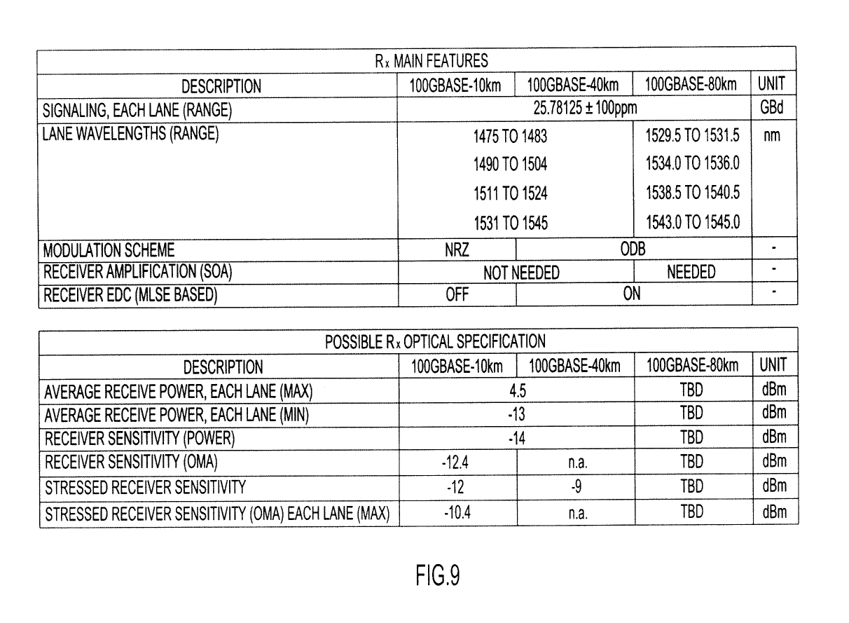

FIGS. 8 and 9 illustrate the Tx and Rx optical specifications, respectively, for an optical module that can support the multiple modulation formats and thus multiple reaches (10 km, 40 km and even an 80 km reach) using the techniques described herein.

In sum, the techniques described herein allow for a 100 G non-standard optical module, as well as a software/firmware mechanism that allows a host device to drive the non-standard optical module over different optical modulation foi mats. There are several benefits of this solution. The optical module can use low-cost optics (similar or less costly than a 100 GBASE-LR4 optical module and certainly less costly than a 100 GBASE-ER4 optical module) with the same bill of materials for 10 km and 40 km links. The optical module can leverage a software/firmware license to turn ON/OFF a “key” to enable the longer reach (40 km, 60 km, 80 km, etc.). Since no SOA amplification (for the 100 GBASE-ER4 case) and no TEC are needed, the estimated power consumption of such an optics configuration is lower than any 100 GBASE-LR4 and ER4 optical modules heretofore known. This will enable an easier transition to a smaller form factor (e.g., the CXP form factor or other similar form factors) optics. In addition, a longer reach interface (or a DWDM-like) interface is provided when a TEC is used in the module. Four wavelengths in an EDFA amplification region (between 1530 to 1560 nm) can be also considered (e.g. in a CFP module as first step to such longer reach interfaces).

The foregoing description provides for an “intelligence” mechanism in the host device to configure the optical module to use one of a plurality of optical modulation schemes. Some particular host device settings can be delegated to the host 10 to enable some host functionalities that can selectively drive a common optics platform in an optical module to work in different modes depending on the application. The multipurpose pluggable host device can meet different reach applications (LR and ER) by accommodating different modulation schemes with respect to the electrical transmit signals supplied to the optical module where the optical modulation is applied to the electrical transmit signals.

The longer reach optical modulation schemes may be part of a feature set for the optical module that a customer enables upon payment of an additional fee. For example, a customer pays a certain price for the optical module hardware. The switch (host) input/output system (10S) in which the optical module is installed will set the optics by default to NRZ modulation (for 10 km). If the customer wants more robustness over 10 km, or foresees any 40 km application on a switch, blade or even at the port level, the customer purchases a software license that will permit the IOS to have access to the Tx and Rx “knobs” in the module to automatically adjust the module configuration to ODB modulation.

The above description is by way of example only.

What is claimed is:

1. An apparatus comprising:
an electrical modulator unit configured to generate electrical transmit signals comprising modulated data in a modulation format;
a connector configured to connect to an optical module that transmits optical signals to an optical fiber; and
a controller configured to be coupled to the electrical modulator unit, wherein the controller is configured to:
select one of a plurality of optical modulation schemes for an optical reach; and
generate a control signal for supply to the optical module via the connector,
wherein the control signal is configured to cause the optical module to generate optical signals from the electrical transmit signals according to the selected optical modulation scheme.

2. The apparatus of claim 1, wherein the controller is configured to generate the control signal comprising a bias control according to the selected optical modulation scheme for supply to the optical module and for use by an optical modulator unit in the optical module so as to configure the optical modulator unit to convert the electrical transmit signals to modulated optical signals for transmission.

3. The apparatus of claim 2, wherein the electrical modulator unit is configured to generate the electrical transmit signals comprising modulated data according to a first modulation format, and wherein the controller is configured to generate the control signal that is configured to cause the optical module to either pass the electrical transmit signals comprising modulated data in the first modulation format or to cause the optical module to convert the modulated data of the electrical transmit signals from the first modulation format to a second modulation format.

4. The apparatus of claim 2, wherein the electrical modulator unit is configured to generate electrical transmit signals comprising modulated data according to any one of a plurality of modulation formats and is responsive to the controller to generate the electrical transmit signals in a particular modulation format according to the selected optical modulation scheme.

5. The apparatus of claim 4, wherein the electrical modulator unit is configured to generate electrical transmit signals comprising modulated data according to a non-return to zero modulation format for optical reaches of a first range and according to a duobinary modulation format for optical reaches of a second range.

6. The apparatus of claim 1, wherein the controller is configured to generate the control signal comprising a modulation selection signal that is configured to control a programmable electrical modulator unit in the optical module to either further process the electrical transmit signals for supply to an optical modulator unit in the optical module or to pass the electrical transmit signals without further processing to the optical modulator unit in the optical module.

7. The apparatus of claim 6, wherein the controller is configured to generate the modulation selection signal that causes the optical module to generate a bias control for the optical modulator unit for use in converting the electrical transmit signals to optical signals according to the selected optical modulation scheme.

8. In combination, the apparatus of claim 1 and the optical module, wherein the optical module comprises an optical modulator unit that is configured to output optical signals according to any one of the plurality of optical modulation schemes, and wherein the optical modulator unit is responsive to the control signal that contains a bias for the optical modulator unit according to the selected optical modulation scheme.

9. In combination, the apparatus of claim 1 and the optical module, wherein the optical module comprises a programmable electrical modulator unit and an optical modulator unit that is configured to output optical signals according to any one of the plurality of optical modulation schemes, wherein the programmable electrical modulator unit is responsive to the control signal to either convert the electrical transmit signals from a first modulation format to a second modulation format for supply to the optical modulator unit or to pass the electrical transmit signals in the first modulation format to the optical modulator unit, wherein the optical modulator unit is responsive to a bias control supplied by the optical module to drive the optical modulator unit to optically modulate the electrical transmit signals according to the selected optical modulation scheme.

10. A method comprising:
generating electrical transmit signals comprising modulated data in a modulation format for conversion to optical signals for transmission on an optical link;
selecting one of a plurality of optical modulation schemes for use according to a desired optical reach; and
generating a control signal for supply to an optical module, wherein the control signal is configured to cause the optical module to generate optical signals from the electrical transmit signals according to the selected optical modulation scheme.

11. The method of claim 10, and further comprising generating a bias control for an optical modulator unit in the optical module according to the selected optical modulation scheme.

12. The method of claim 10, wherein generating the control signal comprises generating a signal that causes the optical module to generate a bias control for an optical modulator unit in the optical module according to the selected optical modulation scheme.

13. The method of claim 10, wherein generating the electrical transmit signals comprises generating electrical transmit signals comprising modulated data according to a first modulation format, and wherein generating the control signal comprises generating the control signal configured to cause the optical module to either pass the electrical transmit signals comprising modulated data in the first modulation format or to cause the optical module to convert the modulated data of the electrical transmit signals from the first modulation format to a second modulation format.

14. The method of claim 10, wherein generating the electrical transmit signals comprises generating the electrical transmit signals comprising modulated data according to a particular one of a plurality of modulation formats based on the selected optical modulation scheme, and wherein generating the control signal comprises generating the control signal that is configured to bias and drive an optical modulator in the optical module to generate optical signals from the electrical transmit signals according to the selected optical modulation scheme.

15. The method of claim 10, and further comprising receiving a feedback signal indicating performance with respect reception of the transmitted optical signals at a destination node and wherein the controller is configured to automatically switch from one optical modulation scheme to another optical modulation scheme based on the feedback signal.

16. A system comprising:
a host device that comprises:
an electrical modulator unit that is configured to generate electrical transmit signals comprising modulated data in a modulation format;
a controller that is configured to select one of a plurality of optical modulation schemes for use according to a desired optical reach and to generate a control signal based on the selected optical modulation scheme;
an optical module that is configured to connect to the host device, the optical module comprising an optical modulator unit that is configured to output optical signals according to any one of the plurality of optical modulation schemes, and wherein the optical module is responsive to the control signal to cause the optical modulator unit to optically modulate the electrical transmit signals according to the selected optical modulation scheme for transmission on an optical fiber.

17. The system of claim 16, wherein the controller is configured to generate the control signal that contains a bias for the optical modulator unit according to the selected optical modulation scheme.

18. The system of claim 17, wherein the optical module comprises a programmable electrical modulator unit that is responsive to the control signal to either convert the electrical transmit signals from a first modulation format to a second modulation format for supply to the optical modulator unit or to pass the electrical transmit signals in the first modulation format to the optical modulator unit, wherein the optical modulator unit is responsive to a bias control supplied by the optical module to drive the optical modulator unit to optically modulate the electrical transmit signals according to the selected optical modulation scheme.

19. The system of claim 16, wherein the electrical modulator unit in the host device is configured to generate electrical transmit signals comprising modulated data of a first modulation format for optical reaches of a first range and according to a second modulation format for optical reaches of a second range.

20. The system of claim 16, wherein the host device receives as input a feedback signal indicating performance with respect reception of the transmitted optical signals at a destination node and wherein the controller is configured to automatically switch from one optical modulation scheme to another optical modulation scheme based on the feedback signal.
